(19) United States
(12) Patent Application Publication
(10) Pub. No.: US 2008/0222896 A1
(43) Pub. Date: Sep. 18, 2008

(54) FIELD STRIPPABLE KNIFE

(75) Inventors: Anthony L. Marfione, Bradford, PA (US); Anthony G. Marfione, Bradford, PA (US)

Correspondence Address: FAY SHARPE LLP, 1100 SUPERIOR AVENUE, SEVENTH FLOOR, CLEVELAND, OH, 44114, US

(73) Assignee: MICROTECH KNIVES, INC., Bradford, PA (US)

(21) Appl. No.: 11/684,744

(22) Filed: Mar. 12, 2007

(51) Int. Cl. B26B 1/04

(52) U.S. Cl. 30/157; 30/160

(57) ABSTRACT

A field-strippable folding knife which can be disassembled without special tools is disclosed. The knife has a blade a tang, and a handle. The handle comprises a male handle portion and a female handle portion which can be joined together. The tang may have two stops. The stops are engaged by a blade locking system to fix the blade in an open position and a closed position.

### BACKGROUND

This application relates broadly to folding knives. Knives that have blades which move from a closed position to an open position are well known. In a folding knife, the blade pivots about an axis normal to a common plane of the handle and blade between a closed position within the handle through an arc to an open position external of the handle. In the open position, a lock prevents the blade from pivoting on the axis during use.

One problem with knives is their permanence of assembly. Should a folding knife or other knife with moving parts get jammed or clogged with dirt, it usually cannot be disassembled without special tools. In the field, this lack of special tools can severely hinder cleaning, use, or repair. A need exists for a knife which can be field-stripped without need of special tools.

### BRIEF DESCRIPTION

Disclosed herein, in various embodiments, is a field strippable knife. The knife comprises a blade; a tang; and a handle. The tang is preferably integral with the blade, rotatable with respect to the handle, and may have two stops. The handle comprises a male handle portion and a female handle portion which are joined together to form the handle. The male handle portion comprises a lock bushing and the female handle portion comprises a female socket shaped to engage the lock bushing. Finally, the knife has a rear handle fastener to hold the male and female handle portions together. In one embodiment, the male and female handle portions can be separated by rotating them so that the lock bushing no longer engages the female socket. The knife may also have a blade locking system which engages the two stops of the tang.

In one embodiment, the rear handle fastener comprises a detent hole and ramp in one handle portion and a peg extending from the other handle portion which engages the detent hole.

In another embodiment, the rear handle fastener comprises a rear lock bushing extending from one handle portion and a rear socket shaped to engage the rear lock bushing in the other handle portion. The female socket and the rear socket each comprise a cam cylinder. The cam cylinder has two ends, has two slots on one end, and engages the lock bushing. The slots are shaped so as to allow a coin or cartridge case rim to be used to rotate the cam cylinder to either engage or disengage the lock bushing.

In some embodiments, the blade locking system comprises a spring and a slide, wherein the slide is positioned so as to engage two stops on the tang. The slide has a first contact end which engages the tang and a second end which engages the spring. The slide may also have a catch. The stops on the tang are located so that the blade locking system locks the blade in an open position at one stop and in a closed position between the male and female handle portions at the other stop. The tang may further comprise a smooth sliding surface between the two stops.

The lock bushing may have at least one ear and in specific embodiments has two ears. The ear may be a ramped ear. This aspect allows for tighter squeezing (a closer fit) when the male and female handle portions are engaged, preventing the blade from moving from side to side during use.

The lock bushing and the female socket at the front end of the knife, used to hold the handle halves together, may be configured so that the male handle portion and female handle portion must be rotated at least 10 degrees relative to each other before the two handle portions can be separated.

If desired, the knife may also comprise a tension lever which helps spring the blade out from its sheathed closed position to the open position.

These and other non-limiting features of the field-strippable knife will be further described hereinafter.

### BRIEF DESCRIPTION OF THE DRAWINGS

The following is a brief description of the drawings, which are presented for the purposes of illustrating the exemplary embodiments disclosed herein, not for limiting them.

FIG. 1 is a side view of the field-strippable knife with the blade in a locked, unsheathed, open position.

FIG. 2 is a side view of the field-strippable knife in a disassembled condition where one handle portion is rotated relative to the other handle portion.

FIG. 3 is an exploded diagram of the field-strippable knife.

FIG. 4 is a view of the interior faces of both handle portions.

FIG. 5 is a view of the lock bushing seen in FIG. 4, separated from the handle portion.

FIG. 6 is a diagram of a second embodiment of the field-strippable knife.

FIG. 7 is a schematic of the cam cylinder.

FIG. 8 shows a knife with the blade in the open position.

FIG. 9 shows a first position in moving the blade of the knife from an open position to a closed position.

FIG. 10 shows a second position in moving the blade of the knife from an open position to a closed position.

FIG. 11 shows a third position in moving the blade of the knife from an open position to a closed position.

FIG. 12 shows a knife with the blade in the closed position.

### DETAILED DESCRIPTION

A more complete understanding of the knives and components disclosed herein can be obtained by reference to the accompanying Figures. These Figures are merely schematic representations based on convenience and the ease of demonstrating the present development and are, therefore, not intended to indicate relative size, dimensions, or location of the devices or components thereof and/or to define or limit the scope of the exemplary embodiments. Although specific terms are used in the following description for the sake of clarity, these terms are intended to refer only to the particular structure of the embodiments selected for illustration in the Figures and are not intended to define or limit the scope of the disclosure. In the Figures and the following description below, it is to be understood that like numeric designations refer to components of like function.

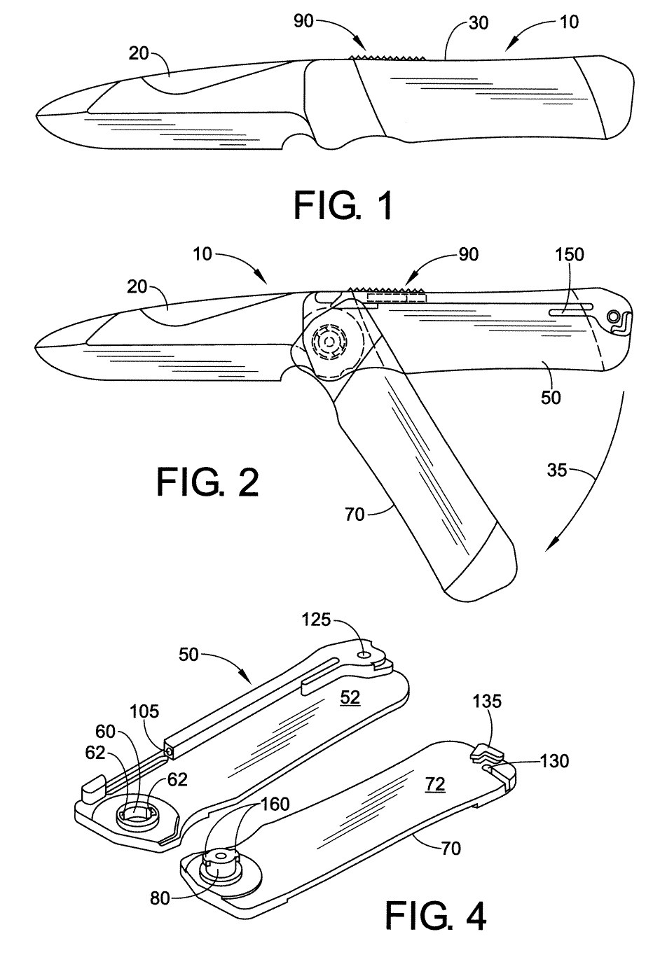

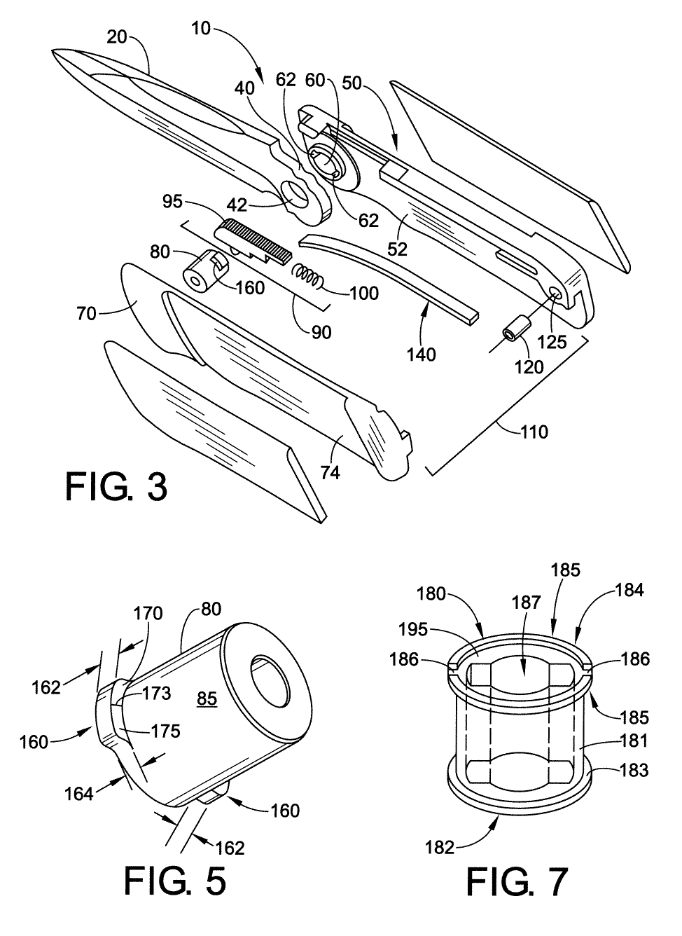

FIG. 1 is a side view of a first exemplary embodiment of the field-strippable knife. The knife 10 comprises a blade 20 having an integral tang 40 (see FIG. 3) and a handle 30. The blade can be folded into the handle by rotating the blade around a pivot point. Here, the handle 30 is shown in an assembled condition.

FIG. 2 is a schematic of the first exemplary embodiment of the field-strippable knife where the handle is shown partially disassembled. The handle 30 comprises a female handle portion 50 and a male handle portion 70. To disassemble the knife, one handle portion (here, the male handle portion 70) is rotated in the direction of the arrow 35 to separate the handle portions

FIG. 3 is an exploded diagram of the field-strippable knife showing its component parts. Only the exterior face of the male handle portion 74 and the interior face of the female handle portion 52 are visible in this diagram. A generally cylindrical lock bushing 80 is fixed to the male handle portion 70. In the depicted embodiment, two identical ears 160 are provided on opposite sides of the lock bushing. In embodiments using an ear as a locking mechanism, the lock bushing 80 has at least one ear 160. In another embodiment, two identical ears 160 are provided which are located from 30 to 150 degrees apart from each other on the lock bushing. This embodiment may be desired to ensure the two handle portions can be joined together in only one orientation. Although the lock bushing 80 is shown as a separate part, this application also contemplates embodiments where the lock bushing is formed as an integral part of the male handle portion.

A female socket 60 shaped to engage the lock bushing 80 is provided in the female handle portion 50 near its front end. The lock bushing 80 passes through a hole 42 in the tang 40 and engages the female socket 60. The center of the hole 42 defines an axis about which the blade pivots, or rotates, between its closed position and its open position.

The knife also comprises a rear handle fastener 110. The rear handle fastener comprises a detent hole 130 (see FIG. 4) and ramp 135 (see FIG. 4) in the male handle portion 70 and a peg 120 fitted into a peg hole 125 in the female handle portion 50. The peg 120 engages the detent hole 130 and ramp 135 to prevent the two handle portions 50 and 70 from disassembling. Other fastener systems are also contemplated.

The knife may have a long, springy, protrusion 150 fixed at only one end inside the knife handle against which the blade rests when folded. The protrusion 150 serves to protect the interior of the handle 30 from being gouged by the blade 20 and also helps keep the knife blade sharper by distributing any contact forces along a greater area.

The knife also has a blade locking system 90, shown here as comprising a slide 95 and a spring 100. If desired, a tension lever 140 may also be included in the knife interior to help spring the blade out from its closed position to its open position.

FIG. 4 is a view of the interior faces of both handle portions. The interior face 52 of the female handle portion 50 has a female socket 60 which is shaped to engage the lock bushing located on the interior face 72 of the male handle portion 70. The depicted lock bushing 80 has two ears 160. The female socket 60 has two recesses 62 shaped and positioned to receive the ears 160. The recesses 62 and the ears 160 are located so that they can align with each other when the handle portions 50, 70 are disassembled. Inside the female socket is an engagement surface 195 (see FIG. 7) which engages the ears 160. In specific embodiments, the male handle portion 70 and female handle portion 50 must be rotated at least 10 degrees relative to each other to disassemble the handle (see arrow 35, FIG. 2). The degree of rotation is generally less than 90 degrees to provide sufficient space for non-alignment of the recesses and ears to assemble the handle. The two handle portions 50, 70, when assembled (see FIG. 3), are prevented from separating because the two ears 160 of the lock bushing are not aligned with the recesses 62 of the female socket 60. The female socket 60 can also be shaped so that the lock bushing 80 must rotate in one direction to assemble and in the opposite direction to disassemble the handle 30.

At the top of the female handle portion is a spring chamber 105 which holds the spring 100 of the blade locking system 90. This spring chamber can be located on either handle portion. A peg hole 125 is located at the rear end of the female handle portion for a peg 120 to be inserted. Of course, the peg can also be made integral to the female handle portion 70. The detent hole 130 and ramp 135 are shown at the rear of the male handle portion 50 and work together as one assembly to receive the peg 120 (see FIG. 3), hold it securely, yet release it upon application of sufficient pressure in the correct direction.

FIG. 5 is an enlarged view of the lock bushing 80. The lock bushing 80 comprises a core 85 having a cylindrical sidewall. Though the lock bushing is depicted as having a hollow center here, this particular aspect is not necessary. The preferred lock bushing has two ears 160, though ears are not necessary. The depicted lock bushing can also be described as having a base fixed to the male handle portion, an intermediate portion, a top portion remote from the base, and ears located at the top portion.

Each ear is a ramped ear. The front side of the ear is flush with one end of the lock bushing 80 and is normal to the axis of the lock bushing 80. The ramped feature is present on the back side of the ear which faces towards the male handle portion and engages the female socket 60. The ear has a leading edge 162 during rotation of the lock bushing 80 inside the female socket 60. The portion of the back side of the ear from the leading edge 162 to about the middle of the ear (shown by line 173) is slanted at an angle, forming a ramp 170. The remainder of the back side of the ear from about the middle of the ear to the trailing edge 164 is a second flat surface 175 which is also normal to the axis of the lock bushing 80. The leading edge 162 is therefore slightly shorter than the trailing edge 164. As a result, rotating the two handle portions causes an engagement surface 195 (see FIG. 7) of the female socket 60 to ride up the ramp 170 of each ear 160, resulting in a tight interference fit between the lock bushing 80 and the female socket 60. The ramp 170 is generally straight, although it can be curved if desired. The number of ears 160 can vary, though it generally ranges from one to six. With greater numbers of ears, the amount of rotation between assembled and disassembled positions in the lock bushing and female socket becomes too small. This makes it harder to operate the knife, weakens its structural integrity, makes the female socket another location in which dirt or other debris can jam the knife, and makes the female socket harder to clean.

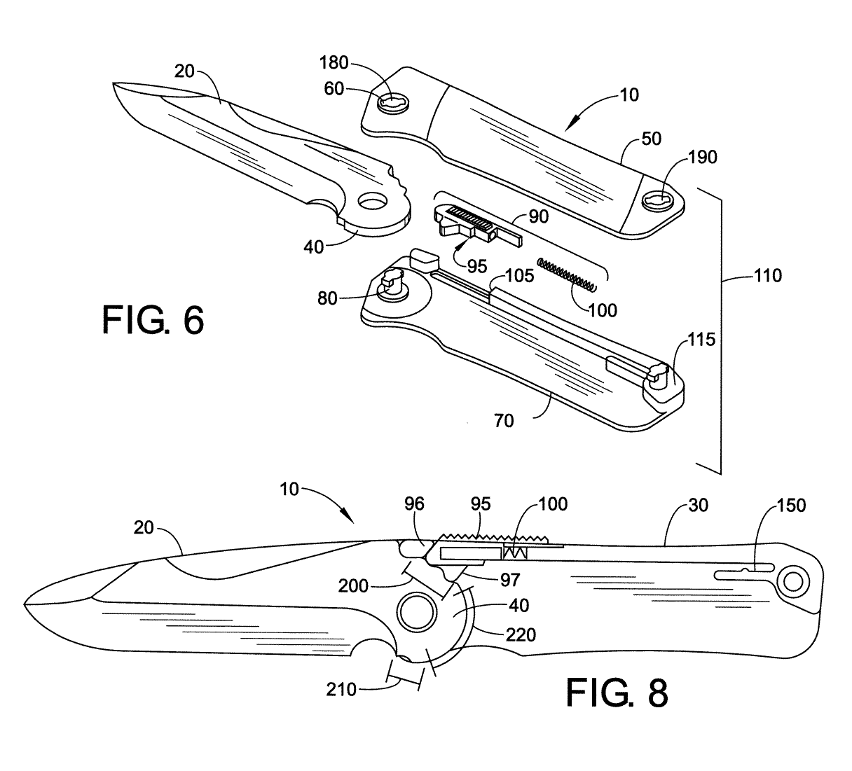

FIG. 6 is a diagram of a disassembled second exemplary embodiment of the field-strippable knife, Again, the knife 10 comprises a blade which has an integral tang 40. The male handle portion 70 has a lock bushing 80 at its front end. The female socket 60 at the front of the female handle portion 50 comprises a cam cylinder 180. In this view, the cam cylinder extends through the body of the female handle portion. The blade locking system 90 is again shown as a slide 95 and spring 100. In this embodiment, the spring chamber 105 (see FIG. 4) is located on the male handle portion 70. The rear handle fastener 110 comprises a second lock bushing 115 on the rear of the male handle portion 70 and another cam cylinder 190 located on the female handle portion 50. This cam cylinder 190 engages the second lock bushing 115. In this embodiment, the handle portions 50 and 70 are separated by rotating the cam cylinders 180, 190 to disengage the lock bushings; the handle portions themselves are not rotated as in the first embodiment of FIG. 2. The handle portions are then simply pulled apart.

FIG. 7 is a schematic of the cam cylinder 180. The cam cylinder extends through the body of the handle portion it is located in and has two ends. The first end 182 is shaped so as to accept the lock bushing 80. This first end 182 of the cam cylinder is located in the interior of the female handle portion. The first end 182 includes a radially extending flange 183 which may be threadably fixed to the cam cylinder 180. The second end of the cam cylinder 184 has a flange 185 with two slots 186. The flange 185 extends radially outward and axially outward from the body 181 of the cam cylinder. The slots 186 are shaped so that a coin, screwdriver, cartridge case rim, or other tool with a flat face can be inserted to turn the cam cylinder 180. Generally, the slots form a straight line. A central bore 187 allows machining of the interior of the cam cylinder to provide a path for the lock bushing 80 and its ears 160. The cam cylinder also has an engagement surface 195 which engages the lock bushing 80 by riding up the ramp 170 of each ear 160. Generally, the female socket 60 (or cam cylinder 180) comprises a central bore 187, at least one recess 62, and an engagement surface 195. The cam cylinder 180 is rotatably mounted in a bore in the female handle portion.

The lock bushing 80, with its ears 160, is inserted through the first end 182 and travels through the central bore 187 to the second end 184. When the cam cylinder is twisted, the engagement surface 195 slides under the ears 160, preventing the lock bushing 80 from being pulled back through the central bore 187.

Here, the engagement surface 195 is shown as being on the second end 184 of the cam cylinder. Obviously, the flange 185 must be high enough that the slots 186 are still usable when the lock bushing is engaged on the engagement surface. However, the engagement surface may be anywhere along the central bore 187. For example, the engagement surface could be near the first end 182 of the cam cylinder.

The tang 40 joins the blade 20 to the handle 30 of the field-strippable knife. The blade and tang are rotatable as a unit with respect to the handle 30. The blade 20 may be rotated between a sheathed closed position inside the handle and an open position in a common plane with the handle extended at the front of the knife. The axis of rotation for the blade 20 and tang 40 is the center of the hole 42 (see FIG. 3) in the tang. The hole 42 is large enough for both the lock bushing 80 and the female socket 60 to pass through it so that they can engage each other. The tang 42 also has two stops, an open stop 200 and a closed stop 210. Between the two stops is a sliding surface 220. These aspects of the tang 40 can best be seen with reference to FIGS. 8-12, which show the interaction of the tang 40 with the blade locking system 90 as the knife is folded up. In these Figures, the knife is shown with one handle portion removed so interior elements are visible.

It should be noted that in the two embodiments shown in FIGS. 4 and 6, the lock bushing 80 is shown as having ears 160. However, the lock bushing 80 is not required to have ears 160 and should be considered as providing a pivot point for the blade 20. The lock bushing 80 and female socket 60 together may comprise any locking mechanism which will join the female handle portion 50 and the male handle portion 70 together. Any locking means which can join and separate the female handle portion 50 and the male handle portion 70 may be used. For example, other locking means which can be used include rivets, screws, and thread fastener pairs.

In FIG. 8, the knife 10 is shown with the blade 20 in the open position. The slide 95 is pushed forward by pressure from the spring 100 so that it engages the open stop 200 with a contact end 96 of the slide and a catch 97 which extends from the bottom of the slide. This engagement of the slide 95 with the open stop 200 prevents the blade from moving, making the blade 20, tang 40, and the handle 30 a rigid unit.

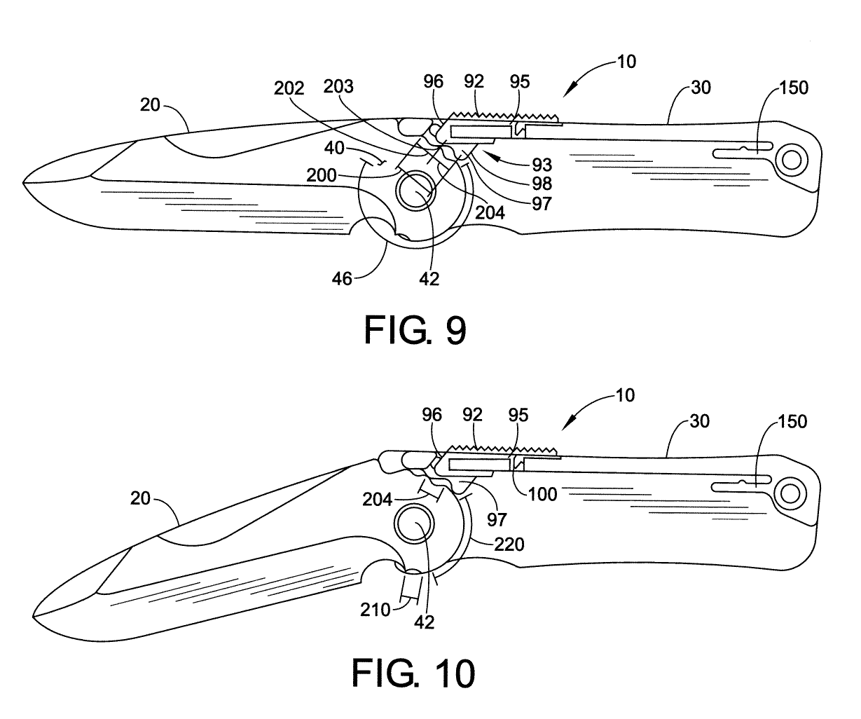

In FIG. 9, the slide 95 is pushed towards the rear of the knife by the knife user. The open stop 200 is thus disengaged from the contact end 96 and the catch 97.

The structure of the slide 95 is more clearly seen in FIG. 9. The bottom surface 93 of the slide extends beyond the top surface 92 of the slide in the direction of the tang 40. The contact end 96 of the slide 95 is an angled face that connects the bottom surface 93 with the top surface 92. Note the contact end 96 is slightly rounded where it meets the bottom surface 93. The catch 97 is located on the bottom 93 of the slide 95. The catch 97 has a back face 98 that extends outwardly from the bottom 93 of the slide and forward towards the contact end 96 of the slide 95. The contact end 96 and the back face 98 of the catch 97 are substantially parallel to each other.

The structure of the open stop 200 is also more clearly seen in FIG. 9. The open stop 200 comprises two notches, a contact notch 202 and a catch notch 204. When the blade is locked open, the contact notch 202 engages the contact end 96 of the slide and the catch notch 204 engages the catch 97 on the bottom of the slide (see FIG. 8). The outer edge of the tang 40 is a portion of the circumference 46 of a circle, with its center at the pivot axis defined by the center of hole 42. The circumference 46 comprises the open stop 200, closed stop 210, and sliding surface 220 (shown in FIG. 8). The catch notch 204 extends into the tang 40 so that at least a portion of the catch 97 is inside the circumference 46 when the slide 95 engages the tang 40. The catch notch 204 is shaped so the back face 98 of the catch 97 is substantially perpendicular to the circumference 46. Because rotational force used to rotate the blade travels tangentially to the circumference 46, this aspect maximizes the locking ability of the catch 97 and catch notch 204. In the open position, the contact end 96 and contact notch 202 provide locking ability, as do the catch 97 and catch notch 204. The contact notch 202 is shaped to generally minimize the distance needed for the slide 95 to travel before the contact end 96 is outside the circumference 46. The contact notch 202 and catch notch 204 are separated by a peak 203.

In FIG. 10, the blade 20 of the knife 10 has been partially rotated about 10 degrees by the knife user. The slide 95 can now be released. Even though the slide 95 contacts the tang 40, the knife user can continue to rotate the blade 20 because the catch notch 204 cannot successfully engage the contact end 96. The contact end 96 meets the catch notch 204 at an acute angle; rotational force is sufficient to prevent them from engaging. The catch notch 204 is also shaped so that when the blade is being opened, the contact end 96 does not engage the peak 203 and the blade continues rotating to a fully open position. Here, the blade 20 has been partially rotated about 10 degrees by the knife user before the user can release the slide 95 and continued rotation is allowed. The degree of rotation required before the user can release the slide 95 is generally the rotation needed to move the peak 203 past the contact end 96 of the slide 95. Generally, the blade must be rotated from 8 to 20 degrees before the slide can be released and continued rotation will still be allowed.

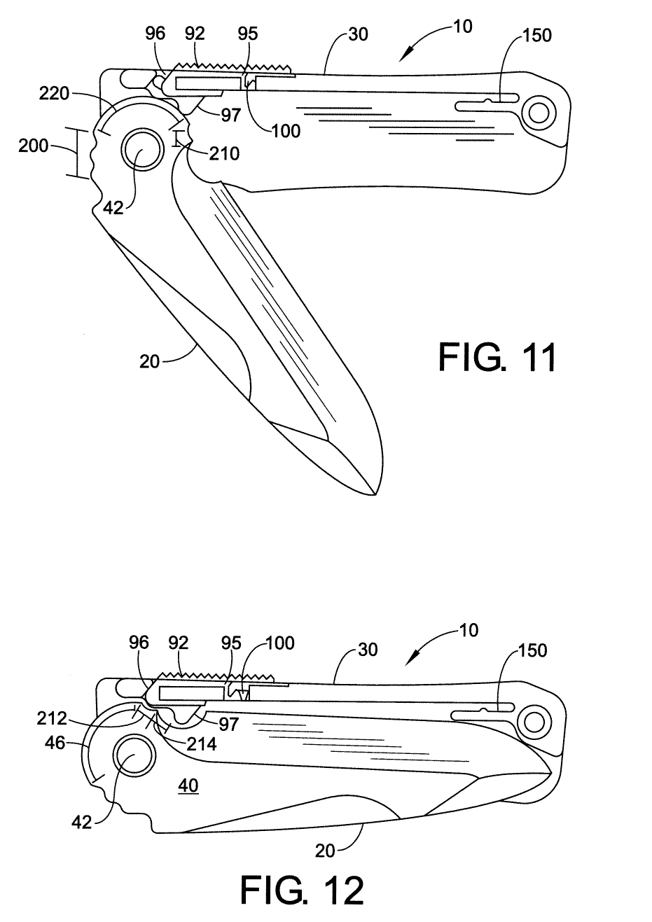

In FIG. 11, the blade is being rotated to its closed position. The contact end 96 and catch 97 of the slide 95 contact the sliding surface 220 of the tang during this rotation. In preferred embodiments, the sliding surface is smooth. However, the sliding surface can also be rough or unfinished as long as it presents no points to engage the slide contact end 96 or catch 97. The key is that the sliding surface 220 cannot engage the slide 95 and prevent the blade from rotating.

In FIG. 12, the knife 10 is fully folded up. The slide 95 is pushed by the spring 100 against the closed stop 210 of the tang 40. The closed stop 210 comprises a contact notch 212 and a catch notch 214. The contact notch 212 engages the contact end 96 of the slide and the catch notch 214 engages the catch 97. The functions of the notches 212, 214 are reversed from that of the open stop 200. Now the contact notch 212 is shaped so the contact end 96 is inside the circumference and the contact end 96 is substantially perpendicular to the circumference 46 to provide locking ability. The catch notch 214 is shaped to hold the catch 97. The edge of the blade 20 may rest against the protrusion 150 located inside the handle 30. Again, when being opened, the contact notch 212 will not engage the catch 97, so the blade can continue rotating.

The open stop 200 and the closed stop 210 do not need to have the same structural configuration; they are defined by the function of stopping the blade in an open position and a closed position. The open stop and the closed stop may be located at least 110 degrees apart from each other around the circumference 46 of the tang. They may generally be between 110 and 210 degrees apart. Similarly, the notches 202, 204, 212, 214 may not have the same structural configuration. The key is that the open stop 200 and closed stop 210 prevent the blade from rotating when the slide 95 engages the tang 40.

The blade locking system 90 is used to lock the blade open. Other blade locking systems may be used with the field-strippable knife of the present disclosure. However, in specific embodiments, the blade locking system comprises a slide 95 and a spring 100. One of the handle portions includes a spring chamber 105 which encloses the spring and guides its travel. Other known blade locking systems include the back lock; the linerlock; and the framelock. In specific embodiments, the user must disengage the blade locking system and rotate the blade from 8 to 20 degrees before the blade locking system can be released and continued rotation will still be allowed.

The rear handle fastener 110 holds the two handle portions 50 and 70 together so that the knife does not disassemble itself until the user desires to do so. Two specific rear fasteners are described with the field strippable knife. In one system, a peg 120 is located on one handle portion and a detent hole and ramp 130 which can engage the peg 120 is located on the other handle portion. In the second system, a second lock bushing 115 on one handle portion engages a cam cylinder 190 on the other handle portion. Other fastener systems may be used.

The present disclosure thus discloses an easily disassembled field-strippable knife. No special tools are needed to strip the knife; a coin can be used in embodiments using a cam cylinder. There are a minimum number of parts; some embodiments have as few as five (5) separate parts. Such a knife can be easily cleaned and/or repaired.

The field-strippable knife of the present disclosure has been described with reference to various exemplary embodiments. Obviously, modifications and alterations will occur to others upon reading and understanding the preceding detailed description. It is intended that the knife of the present disclosure be construed as including all such modifications and alterations insofar as they come within the scope of the appended claims for the equivalents thereof.

1. A field-strippable folding knife, comprising:
a blade having a tang;
a male handle portion comprising a lock bushing;
a female handle portion which may be disassembled from the male handle portion, comprising a female socket shaped to engage the lock bushing; and
a rear handle fastener.

2. The field-strippable knife of claim 1, wherein the rear handle fastener comprises a detent hole and ramp in one handle portion and a peg extending from the other handle portion which engages the detent hole and ramp.

3. The field-strippable knife of claim 1, wherein the rear handle fastener comprises a rear lock bushing having at least one ear, the lock bushing extending from one handle portion, and a rear socket in the other handle portion which is shaped to engage the rear lock bushing.

4. The field-strippable knife of claim 3, wherein the female socket and the rear socket each comprise a cam cylinder, the cam cylinder having a first end shaped to accept the rear lock bushing having at least one ear and a second end having an outwardly extending flange with two slots.

5. The field-strippable knife of claim 1, wherein the lock bushing further comprises a total of from one to six ears.

6. The field-strippable knife of claim 5, wherein at least one ear is a ramped ear.

7. The field-strippable knife of claim 1, wherein the lock bushing has two ears located on opposite sides of the lock bushing.

8. The field-strippable knife of claim 1, wherein the lock bushing has two ears located from 30 to 150 degrees apart from each other on the lock bushing.

9. The field-strippable knife of claim 1, wherein the female socket comprises a central bore, at least one recess, and an engagement surface.

10. The field-strippable knife of claim 1, wherein the male handle portion and female handle portion must be rotated from 10 to 90 degrees relative to each other before the two handle portions can be separated.

11. The field-strippable knife of claim 1, further comprising a tension lever located between the male handle portion and the female handle portion.

12. The field-strippable knife of claim 1, further comprising a protrusion fixed at one end and located on one handle portion.

13. The field-strippable knife of claim 1, further comprising a blade locking system comprising a spring, a slide, and two stops on the tang;
wherein the spring pushes the slide against the tang; and
wherein the slide is positioned so as to selectively engage one or the other of the two stops of the tang.

14. The field-strippable knife of claim 13, wherein one stop is located so that the blade locking system locks the blade in an open position and the other stop is located so that the blade locking system locks the blade in a closed position.

15. The field-strippable knife of claim 1, further comprising a blade locking mechanism, wherein when the blade locking system is disengaged, the blade must be rotated from 8 to 20 degrees before the blade locking system can be released and continued rotation of the blade will still be allowed.

16. A field-strippable folding knife, comprising:
a blade having a tang;
a male handle portion comprising a lock bushing; and
a female handle portion comprising a female socket located at a front end of the female handle portion;
the lock bushing and female socket together comprising locking means for joining and separating the male handle portion and the female handle portion.

17. The field-strippable knife of claim 16, further comprising a blade locking mechanism, wherein when the blade locking system is disengaged, the blade must be rotated from 8 to 20 degrees before the blade locking system can be released and continued rotation of the blade will still be allowed.

18. The field-strippable knife of claim 16, further comprising a slide and a spring located to push the slide against the tang;
wherein the slide comprises a contact end and a catch extending from the bottom of the slide, the catch having a back face;
wherein the tang comprises an open stop and a closed stop located along a circumference defined by a pivot axis extending normally through the tang; and
wherein the open stop comprises a catch notch shaped so that when the open stop engages the catch, the catch is inside the circumference and the back face is substantially perpendicular to the circumference.

19. The field-strippable knife of claim 18, wherein the two stops are located from 110 to 210 degrees apart from each other around the circumference

20. A field-strippable folding knife, comprising:
a blade having a tang;
a male handle portion comprising a lock bushing located at a front end and a lock bushing located at a rear end, each lock bushing having two ramped ears; and
a female handle portion comprising a cam cylinder located at a front end and a cam cylinder located at a rear end, each cam cylinder having a first end shaped to accept a lock bushing having two ramped ears and a second end having an outwardly extending flange with two slots.

21. The field-strippable knife of claim 20, further comprising a blade locking mechanism, wherein when the blade locking system is disengaged, the blade must be rotated from 8 to 20 degrees before the blade locking system can be released and continued rotation of the blade will still be allowed.

22. The field-strippable knife of claim 20, further comprising a spring and a slide, the slide comprising a contact end, a second end opposite the contact end which contacts the spring, and a catch extending from the bottom of the slide, the catch having a back face;
wherein the tang has a hole through which the lock bushing at the front end of the male handle portion can engage the cam cylinder located at the front end of the female handle portion;
wherein a pivot axis extends normally through the tang and defines a circumference of the tang;
wherein the tang further comprises an open stop and a closed stop along the circumference; and
wherein the open stop comprises a catch notch shaped so that when the open stop engages the catch, the catch is inside the circumference and the back face is substantially perpendicular to the circumference.
